(19) United States
(12) Patent Application Publication
(10) Pub. No.: US 2003/0219211 A1
(43) Pub. Date: Nov. 27, 2003

(54) Method for aligning optical axis of an optical module

(76) Inventors: Yu-Sik Kim, Suwon-shi (KR); Mun-Kue Park, Suwon-shi (KR)

Correspondence Address: CHA & REITER, 411 HACKENSACK AVE, 9TH FLOOR, HACKENSACK, NJ, 07601, US

(21) Appl. No.: 10/425,146

(22) Filed: Apr. 29, 2003

(30) Foreign Application Priority Data
May 22, 2002 (KR) 2002-28400
Jan. 27, 2003 (KR) 2003-5207

(51) Int. Cl. G02B 6/26; G02B 7/02

(52) U.S. Cl. 385/52; 385/33; 359/811

(57) ABSTRACT

A method for aligning an optical axis of an optical module is disclosed. The method comprises the steps of forming a groove to enable settlement of a lens system in a position spaced apart by a predetermined distance from a position where a semiconductor laser is settled down on the submount; settling the lens system in the groove, bonding a portion of the groove and the lens system, covering the lens system with a groove lid with a predetermined shape, and fixing the groove lid to the top surface of the submount.

### CLAIM OF PRIORITY

This application claims priority under 35 U.S.C. § 119 to an application entitled “Method for Aligning Optical Axis of an Optical Module” filed in the Korean Intellectual Property Office on May 22, 2002 and assigned Ser. No. 2002-28400, and an application entitled “Method for Aligning Optical Axis of an Optical Module” filed in the Korean Intellectual Property Office on Jan. 27, 2003 and assigned Ser. No. 2003-5207, the contents of both applications are incorporated herein by reference.

### BACKGROUND OF THE INVENTION

1. Field of the Invention

The present invention relates generally to a method for packaging optical elements, and in particular, to a method for aligning an optical axis between a flip chip-bonded semiconductor laser and an optical system having an optical module serving as an optical source for optical communication.

2. Description of the Related Art

In an optical communication system, a general optical module for optical communication includes a semiconductor laser, a plurality of optical elements, and an optical fiber or ferrule for transmitting light beams outputted from the semiconductor laser.

An optical communication network using an optical fiber suffers a considerable signal loss during long-distance transmission of an optical signal. This is due to the scattering of the optical signal, caused by dispersion of the wavelength in use, and to material dispersion of the material of the optical fiber.

In order to compensate for the above defects, two methods have been proposed. In the first method, a lens system for condensing an optical signal is mounted on an optical module used as an optical source for optical communication. The lens system improves coupling efficiency between the optical fiber and the semiconductor laser. In the second method, an incident plane of an optical fiber is rectangularly cut off, upon which an optical signal is incident, to improve its condensing efficiency.

In particular, in the lens system method for aligning an optical axis of an optical module mounted, a method is used for actively aligning an aspheric lens or a grin lens on the top surface of a gold (Au)-coated silica substrate by laser welding or soldering.

The error range for the alignment of an optical axis is limited within approximately 1 μm from an optimum optical coupling position, regardless of a data rate of the optical module. Typically, a known method for aligning an optical axis within the limited error range is divided into two categories: an active and a passive alignment method. The active alignment method aligns the optical axis while the optical module is being operated. The active alignment method provides a high precision, but increases time and expenses due to its complicated process.

FIG. 1 is a side view of an optical module based on the conventional optical axis alignment method. FIG. 2 illustrates a perspective view of the optical module of FIG. 1. Referring to FIGS. 1 and 2, a submount 130 includes a support 112 for adjusting the height, represented by an Y axis, of a semiconductor laser 111, the semiconductor laser 111 mounted on the top surface of the support 112, and a lens system 120 being spaced apart by a predetermined gap from the semiconductor laser 111. Lens system 120 is comprised of a lens 122 for converging an optical signal and a metal housing 121 in which lens 122 mounted.

The conventional optical axis alignment method for an optical module includes a first step of fixing semiconductor laser 111 to the top surface of submount 130, a second step of aligning an optical axis of lens system 120 comprised of metal housing 121 and lens 122 on submount 130, and a third step of fixing lens system 120 to the top surface of submount 130 by laser welding.

In the first step, gold (Au) is coated all over submount 130 made of a Cu—W alloy, and then semiconductor laser 11 is bonded to the top surface of dielectric support 112 mounted on submount 130, by flip chip bonding.

The direction of the light beam outputted from semiconductor laser 111 is defined by the Z axis, along which an optical axis between optical elements constituting the optical module is aligned. The direction of the height of semiconductor laser 111, being perpendicular to the Z axis, is defined by the Y axis, and the direction of the width of semiconductor laser 111 is defined by the X axis.

In the second step, the optical axis of lens system 120 is aligned with a light beam outputted from semiconductor laser 111 on submount 130. Lens system 120, as stated above, is comprised of lens 122 for converging a light beam outputted from semiconductor laser 111, and metal housing 121 for mounting lens 122 therein. Typically, a plane-convex type grin or aspheric lens, which is commonly used as a condensing lens, may be used as lens 122.

The optical axis of lens system 120 is aligned by the active alignment method that aligns the optical axis while continuously irradiating a light beam by semiconductor laser 111. Lens system 120 is aligned along with the directions of the X and Y axes, while changing the distance between lens system 120 and semiconductor laser 111. The active alignment method provides a high precision, but increases time and expenses for alignment of an optical axis, causing an increase in the cost.

In the third step, lens system 120, an axis of which has been optimally aligned, is fixed to the top surface of submount 130. In this step, lens system 120 is fixed to the top surface of submount 130 by irradiating a laser beam such as YAG (Yttrium Aluminum Garnet) laser to laser welders 123 inserted between the top surface of submount 130 and the bottom surface of lens system 120.

However, such a conventional optical axis alignment method for an optical module may distort (or dealign) an optical axis of lens system 122 in the third step of melting laser welders 123 after alignment of the optical axis. In the case of a lens system that cannot be housed using a metal casing, it is very difficult to precisely align and fix the optical axis. In addition, although the active alignment method provides high precession, it increases processing time causing a decrease in the yield.

### SUMMARY OF THE INVENTION

In accordance with the principles of the present invention a method for aligning an optical axis of an optical module is provided, which reduces or overcomes the limitations of the prior art. The method comprises forming a groove on a submount to enable settlement of a lens system in a position spaced apart by a predetermined distance from a position where a semiconductor laser is settled down on the submount; settling the lens system in the groove, and applying a bonding agent to a portion where the groove contacts with the lens system; and covering the lens system with a groove lid in a shape of a box, a lower end of which is opened, and fixing the groove lid to a top surface of the submount.

### BRIEF DESCRIPTION OF THE DRAWINGS

The present invention will become more apparent from the following detailed description when taken in conjunction with the accompanying drawings in which:

FIG. 1 is a side view of an optical module based on the conventional optical axis alignment method;

FIG. 2 illustrates a perspective view of the optical module of FIG. 1;

FIGS. 3A to 3E are plan views illustrating a process of aligning an optical axis of an optical module according to an embodiment of the present invention;

FIG. 4A is a side view illustrating a structure of the optical module shown in FIG. 3D;

FIG. 4B illustrates the optical module of FIG. 3E, an axis of which is aligned;

FIG. 5 is a front view illustrating an optical module with a groove lid put thereon;

FIG. 6 is a flowchart illustrating a process of fabricating an optical module according to an embodiment of the present invention;

FIG. 7 is a flowchart illustrating a process of aligning an optical axis of an optical module according to an embodiment of the present invention; and

FIG. 8 is a graph illustrating the result obtained by conducting a heat shock test on the optical module with a groove lid according to an embodiment of the present invention.

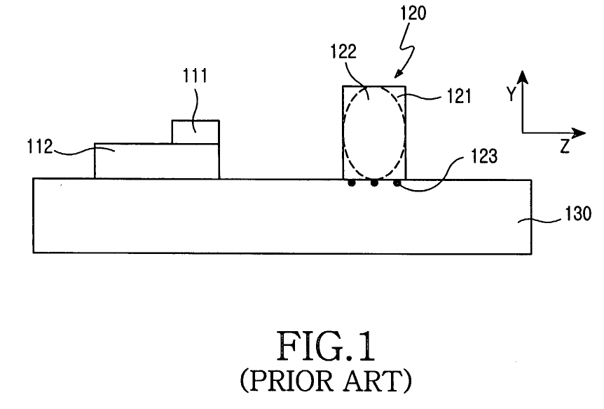

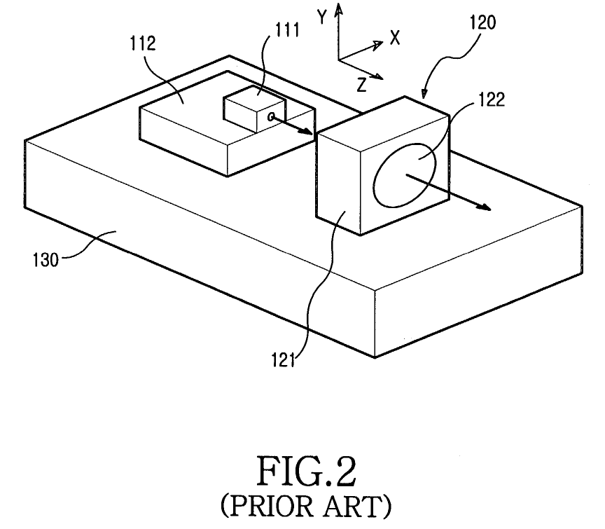

### DETAILED DESCRIPTION OF THE PREFERRED EMBODIMENT

In the following description of the present invention, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. Moreover, it will be recognized that certain aspects of the figures are simplified for explanation purposes and that the full system environment for the invention will comprise many known functions and configurations all of which need not be shown here. In the drawings, the same or similar elements are denoted by the same reference numerals even though they are depicted in different drawings.

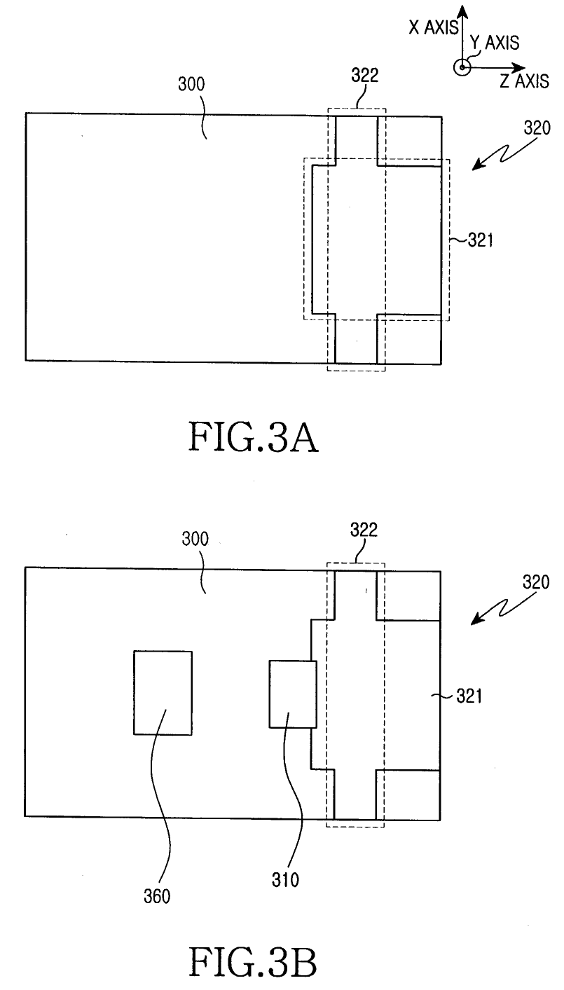

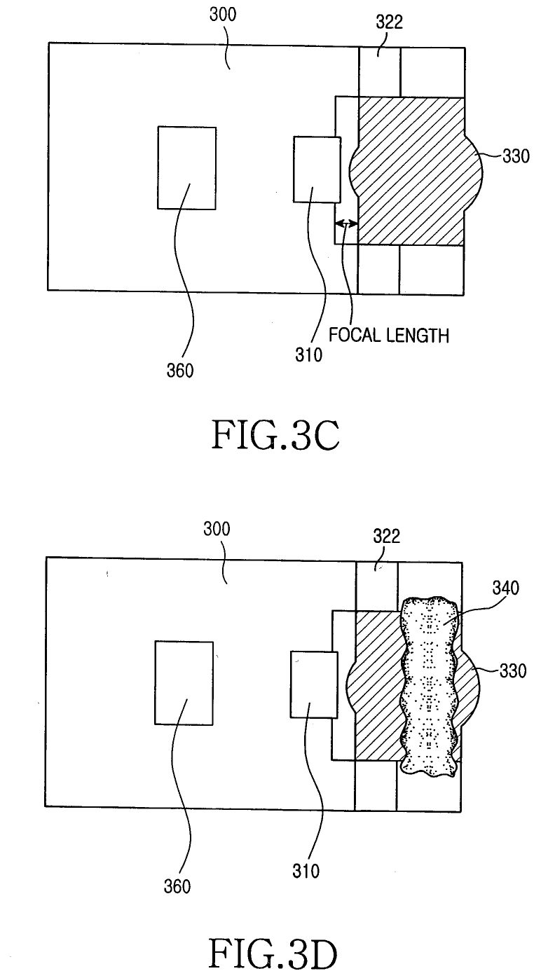

FIGS. 3A to 3E are plan views illustrating a process of aligning an optical axis of an optical module according to an embodiment of the present invention. FIG. 4A is a side view illustrating a structure of the optical module shown in FIG. 3D. Particularly, FIGS. 3E and FIG. 4B illustrate the optical module, an axis of which is aligned.

Referring to FIGS. 3A to 4B, an optical module according to the present invention includes a groove 320 formed to settle a lens system 330 down on a silica submount 300, a semiconductor laser 310 fixed to a predetermined position of the submount 300, the lens system 330 settled down in the groove 320, a groove lid 350 in the form of a box, a lower end of which is opened to cover an upper portion of the lens system 330, and a photo diode 360 for monitoring strength of a laser beam outputted from semiconductor laser 310. Submount 300 is made of SiOB.

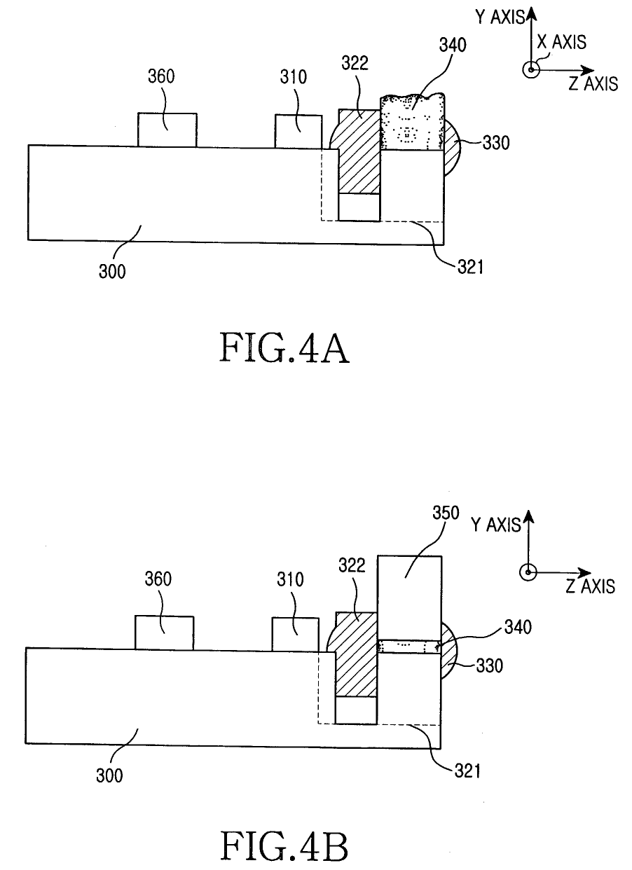

A process of manufacturing an optical module according to an embodiment of the present invention will now be described with reference to FIGS. 3A to 4B. FIG. 6 is a flowchart illustrating a process of fabricating an optical module according to an embodiment of the present invention. Referring to FIG. 6, a proposed method for aligning an optical axis of an optical module according to the present invention includes a first step 510 of forming a groove (preferably having a V shape) on a submount, a second step 520 of bonding a semiconductor laser to the submount by flip chip bonding, and a third step 530 of settling a lens system down in the groove and then applying a bonding agent thereto.

As mentioned above, the direction of a light beam outputted from semiconductor laser 310 is defined by the Z axis, the direction of the height of semiconductor laser 310, representing the depth of the groove 320, is defined by the Y axis, and the direction of the width of semiconductor laser 111, being perpendicular to the Z and Y axes, is defined by the X axis. The X and Y axes become the basis along which an optical axis of lens system 330 is aligned and settled.

Referring to FIG. 3A, first step 510 is performed by setting a position where semiconductor laser 310 will be settled down on the top surface of submount 300, and then forming, on submount 300, groove 320 for settling a lens system 330 in a position spaced apart by a predetermined distance from the position where semiconductor laser 310 is settled down on the submount 300.

First step 510 includes a first substep of forming a first alignment groove 321 for aligning and settling lens system 330 along with the X and Y axes in a predetermined position of submount 300, and a second substep of forming a second alignment groove 322 for adjusting, along with the Z axis, lens system 330 to be spaced apart by its focal length from semiconductor laser 310.

First alignment groove 321 can be formed in various shapes, preferably in a V shape, by etching, and also formed in parallel to the direction of the light beam. That is, first alignment groove 321 is formed straight from one end of submount 300 to the position where semiconductor laser 310 will be settled down. The height of first alignment groove 321, represented by the Y axis, and the width of first alignment groove 321, represented by the X axis, are formed in such a way that lens system 330 can be aligned and settled in a position where a light beam outputted from semiconductor laser 310 can pass through the center of lens system 330. That is, a settlement height for lens system 330 can be adjusted by controlling the width of first alignment groove 321, represented by the X axis.

Second alignment groove 322 is formed by dicing or etching in a position spaced apart by a predetermined distance from the position where semiconductor laser 310 will be settled down, and is perpendicular to first alignment groove 321. Moreover, as second alignment groove 322 is formed in a position spaced apart by a focal length of lens system 330 from the position where semiconductor laser 310 will be settled down, lens system 330 can be settled down in the position spaced apart by its focal length from semiconductor laser 310.

Briefly, groove 320 is formed in a predetermined position on submount 300 using the the position where semiconductor laser 310 will be settled down as a basis/The width and height of groove 320 are adjusted by etching or dicing so that a light beam can be incident upon the center of lens system 330. Groove 320 is formed by dicing or etching and can be formed in various shapes, preferably in a V shape.

Referring to FIG. 3B, second step 520 is performed by fixing semiconductor laser 310 to a predetermined position on submount 300 by flip chip bonding. A settlement position of semiconductor laser 310 is set to a position where semiconductor laser 310 can he spaced apart by a focal length of lens system 330 from lens system 330. In addition, as semiconductor laser 310 is situated such that its light emitting surface can be hung at an end of first alignment groove 321 A light beam outputted from semiconductor laser 310 is prevented from being reflected or scattered by first alignment groove 321.

The flip chip bonding is a technique for bonding a pad (not shown) having the same or similar size and shape as semiconductor laser 310 to the top surface of submount 300 in a position where semiconductor laser 310 is settled down on the top surface of submount 300. Semiconductor laser 310 is placed on the top surface of the pad and then hot-melt bonding is performed at high temperature. Surface tension occurs on the pad during hot meltingresulting in a remarkably reduced horizontal alignment error without additional adjustment. In addition, photo diode 360 is situated in such a way that it faces lens system 330, with semiconductor laser 310 intervening between them. As a result, photo diode 360 serves to monitor a variation in strength of the light beam outputted from semiconductor laser 310.

Referring now to FIGS. 3C and 3D, third step 530 is performed by settling lens system 330 down in groove 320 so that the light beam outputted from semiconductor laser 310 can pass through the center of lens system 330. Then a bonding agent 340 is applied thereto for fixing. The optical axis representing the direction of the light beam outputted from semiconductor laser 310 is defined as the Z axis, the vertical direction from the surface of submount 300 to the light beam is defined as the Y axis, and an axis perpendicularly crossing the Z and Y axes is defined as the X axis. Third step 530 finely adjusts the optical axis of lens system 330 after settling lens system 330 down in groove 320 so that the light beam outputted from semiconductor laser 310 can pass through the optical axis of lens system 330 within a minimum error range. Thermosetting epoxy resin is typically used as bonding agent 340 and is applied to a portion of lens system 330 where it contacts groove 320.

That is, after lens system 330 is settled down in first alignment groove 321, lens system 330 is finely aligned so that the light beam outputted from semiconductor laser 310 can pass through the center of lens system 330. Lens system 330 is aligned in such a way that its end is hung at an end of the second alignment groove 322, so lens system 330 is settled down in a position spaced apart by its focal length from semiconductor laser 310.

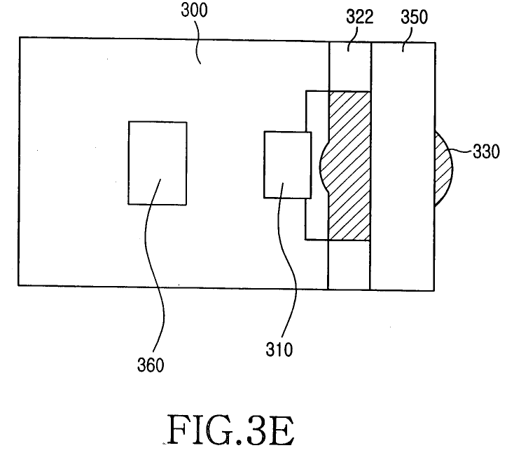

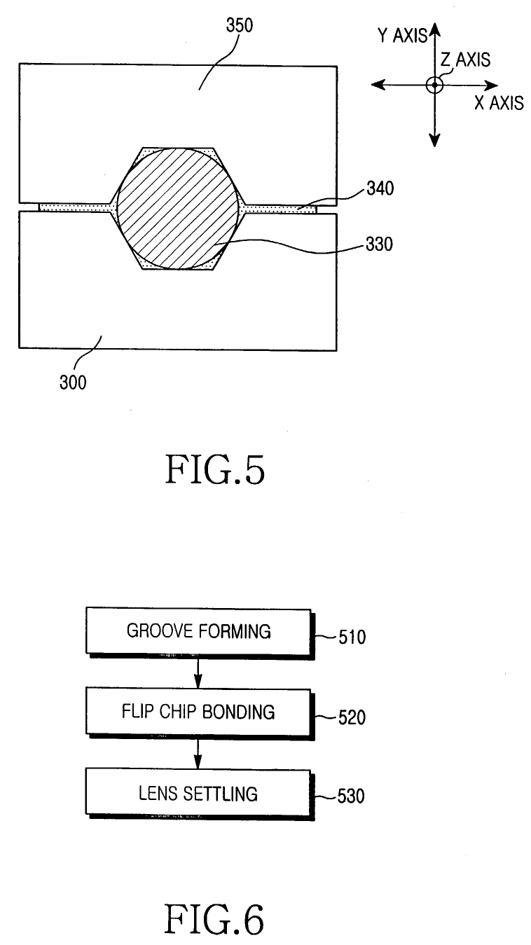

FIG. 5 is a front view illustrating an optical module with a groove lid put thereon. FIG. 7 is a flowchart illustrating a process of aligning an optical axis of an optical module according to an embodiment of the present invention. Referring to FIGS. 5 and 7, the proposed optical axis alignment method for an optical module includes a first step 610 of forming a groove, a second step 620 of performing flip chip bonding, a third step 630 of settling a lens system, a fourth step 640 of fixing a groove lid in the form of a box, a lower end of which is opened, to the top surface of a submount, and a fifth step 650 of hardening a bonding agent.

Referring back to FIG. 3A, first step 610 is performed by forming groove 320 for settling lens system 330 down on submount 300. Referring to FIG. 3B, second step 620 is performed by bonding semiconductor laser 310 to the submount 300 by flip chip bonding. Referring to FIG. 3C, third step 630 is performed by settling lens system 330 down in groove 320 and then applying bonding agent 340 thereto. Submount 300 is made of SiOB. Photo diode 360 is situated in such a way that it faces lens system 330 with semiconductor laser 310 interposed between them, thus photo diode 360 serves to monitor the variation in strength of the light beam outputted from semiconductor laser 310.

Referring to FIGS. 3D and 4A, fourth step 640 is performed by covering lens system 330 with groove lid 350 in the form of a box, a lower end of which is opened. Then groove lid 350 is fixed to the top surface of submount 300. Groove lid 350 has a shape of a box with a bottom surface opened and also has the same width as the width of submount 300 so that an upper portion of lens system 330 can be inserted into groove lid 350. As a result, optical axis-aligned lens system 330 can be prevented from being dealigned, and can be stably fixed to groove 320.

Referring to FIGS. 3E and 4B, fifth step 650 is performed by hardening bonding agent 340 applied to the base surface of groove 320 and the top surface of lens system 330 by heating the optical module at predetermined temperature. For bonding agent 340, thermosetting epoxy resin is typically used. In order to harden bonding agent 340, submount 300 is put on a thermal place/pad or put in a thermal chamber, and then heated at the predetermined temperature.

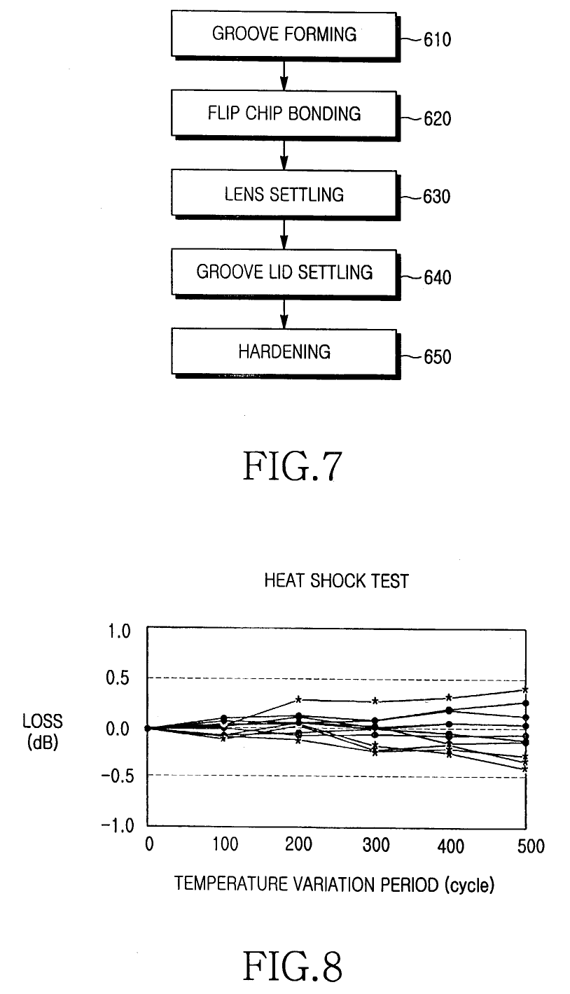

FIG. 8 is a graph illustrating the result obtained by conducting a heat shock test on the optical module with a groove lid according to an embodiment of the present invention. In the graph, the horizontal axis represents the number of repeating a process of changing temperature of the optical module from −45° C. to +85° C., and the vertical axis represents the measured optical loss of the optical module.

Referring to FIG. 8, the heat shock test on the optical module was conducted by repeatedly changing the temperature of the optical module between −45° and +85° C. for a particular time period. The optical loss of the optical module was measured for the cases where the number of repetitions is 100, 200, 300, 400 and 500.

In order to pass the heat shock test, the optical modules should have an optical loss between −0.5 dB and +0.5 dB when the heat shock test was performed 500 times on 11 sample optical modules. It can be noted from FIG. 8 that the optical loss has a value between −0.5 dB and +0.5 dB even after the heat shock test was performed 500 times on the 11 samples.

As described above, the present invention provides a passive optical axis alignment method for (1) forming a groove so that a lens system can be settled down in a predetermined position on a submount, (2) aligning an optical axis of the lens system in the groove, and (3) applying epoxy resin thereto for bonding. Advantageously the invention contributes to easy alignment and adjustment of the optical axis and a reduction in the cost and processing time. In addition, as a groove lid is used, the optical axis of the optical module can be aligned more stably, thereby improving reliability of the products.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for aligning an optical axis of an optical module, the method comprising the steps of:
(a) forming a groove to enable settlement of a lens system in a position spaced apart by a predetermined distance from a position where a semiconductor laser is settled down on the submount;
(b) fixing the semiconductor laser to a surface of the submount;
(c) settling the lens system in the groove; and
(d) bonding a portion of the groove and the lens system.

2. The method of claim 1, wherein the semiconductor laser is fixed to a top surface of the submount.

3. The method of claim 1, wherein the step (d) further includes applying an epoxy resin to a portion of the groove which contact the lens system.

4. The method of claim 1, wherein the groove is formed by etching and dicing.

5. The method of claim 1, wherein a width and height of the groove are adjusted by etching and dicing so that a light beam outputted from the semiconductor laser can pass through a center of the lens system.

6. The method of claim 1, wherein the step (c) further includes applying a hardening agent to the lens system and the groove for bonding.

7. A method for aligning an optical axis of an optical module, the method comprising the steps of:
forming a groove to enable settlement of a lens system in a position spaced apart by a predetermined distance from a position where a semiconductor laser is settled down on the submount;
fixing the semiconductor laser to a top surface of the submount;
settling the lens system in the groove;
applying a bonding agent to a portion where the groove contacts with the lens system; and
covering the lens system with a groove lid.

8. The method of claim 7, wherein the groove lid is in a shape of a box, a lower end of which is opened.

9. The method of claim 7, further including the step of fixing the groove lid to the top surface of the submount.

10. The method of claim 7, further comprising the step of putting the submount on a thermal plate and heading the thermal plate at predetermined temperature to harden the bonding agent, wherein the bonding agent is epoxy resin.

11. The method of claim 7, further comprising the step of heating the submount at predetermined temperature to harden the bonding agent, wherein the bonding agent is epoxy resin.

12. The method of claim 11, where a thermal chamber is used to heat the submount.

13. A method for aligning an optical axis of an optical module having a semiconductor laser fixed to a surface of a submount, the method comprising the steps of:
forming a groove on a submount;
aligning an optical axis of a lens system, using the groove; and
bonding a portion of the groove and the lens system.

14. The method of claim 13, wherein the step of forming the groove is performed to enable settlement of the lens system in a position spaced apart by a predetermined distance from a position where the semiconductor laser is settled down on the submount.
